(19) United States
(12) Patent Application Publication
(10) Pub. No.: US 2014/0249916 A1
(43) Pub. Date: Sep. 4, 2014

(54) SYSTEM AND METHOD FOR PROVIDING MOBILE GROCERY BUDGET APPLICATION

(71) Applicant: Capital One Financial Corporation, McLean, VA (US)

(72) Inventor: Kristina VERHAEGHE, Charlottesville, VA (US)

(73) Assignee: Capital One Financial Corporation, McLean, VA (US)

(21) Appl. No.: 14/196,532

(22) Filed: Mar. 4, 2014

Related U.S. Application Data
(60) Provisional application No. 61/772,031, filed on Mar. 4, 2013.

(51) Int. Cl. G06Q 40/00; G06Q 30/06

(52) U.S. Cl. CPC G06Q 40/12; G06Q 30/0633
USPC 705/14.51; 705/26.8; 705/30

(57) ABSTRACT

The present disclosure relates to systems and methods for providing a mobile shopping budget application. The system includes an account processor that receives, via a network, location data associated with the current location of an account holder, product data, and budget data, a database that stores the received location, product and budget data, and an aggregator that determines a total price based on at least the location data, product data, and budget data, and provides a virtual shopping basket to the account holder based at least on the product data and budget data.

### CROSS-REFERENCE TO RELATED APPLICATIONS

This application claims priority to U.S. Provisional Patent Application No. 61/772,031, filed on Mar. 4, 2013, the entire contents of which is incorporated herein by reference.

### FIELD OF THE DISCLOSURE

The present disclosure relates to systems and methods for providing a mobile grocery budget application to one or more users.

### BACKGROUND OF THE DISCLOSURE

Currently, shoppers at a store who wish to limit spending using a budget must keep track of spending and manually compare what they are spending at a store to a budget. If a shopper is grocery shopping, it is difficult to keep track of the total cost of the items in the shopping cart while simultaneously comparing the cost with a budget. Furthermore, shoppers will have difficulty factoring in taxes and discounts or coupons that are available. Shoppers are likely to miscalculate costs, go over budget, or not realize how far they are over budget until after they bring their items to the cashier for purchase.

These and other drawbacks exist.

### SUMMARY OF THE DISCLOSURE

The present disclosure relates to systems and methods for providing a mobile shopping budget application. The system includes an account processor that receives, via a network, location data associated with the current location of an account holder, product data, and budget data, a database that stores the received location, product and budget data, and an aggregator that determines a total price based on at least the location data, product data, and budget data, and provides a virtual shopping basket to the account holder based at least on the product data and budget data.

According to various embodiments, a mobile device includes a global positioning module that determines the location of the mobile device, an input/output interface that receives and transmits, via a network, product data and the location of the mobile device, an interface that receives inputted budget data, local storage that stores the location of the mobile device, product and budget data, and a processor that determines a total price based on at least the product data and budget data, and provides a virtual shopping basket to a user of the mobile device based at least on the product data and budget data.

According to various embodiments, a method for providing a mobile shopping budget includes receiving, via a network, location data from a mobile device associated with a user, receiving, via a network, identifying data from the mobile device for one or more products, wherein the identifying data for each of the one or more products comprises price data, receiving, via a network, budget data from the mobile device, aggregating the price data associated with the one or more products with the location data to determine cost data, comparing the cost data with the budget data, and providing the user with the results of the comparison between the cost data and the budget data.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of a system for providing a mobile budget application to an account holder, according to an example embodiment of the disclosure; and

FIG. 2 depicts an example system for providing purchase-data driven statements to an account holder, according to an example embodiment of the disclosure;

FIG. 3 depicts an example system point of sale system, according to an example embodiment of the disclosure;

FIG. 4 depicts a schematic diagram of a method for providing a mobile budget application to an account holder, according to an example embodiment of the disclosure.

### DETAILED DESCRIPTION OF THE EMBODIMENTS

The following description is intended to convey a thorough understanding of the embodiments described by providing a number of specific example embodiments and details involving systems and methods for providing a mobile budget application to an account holder. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

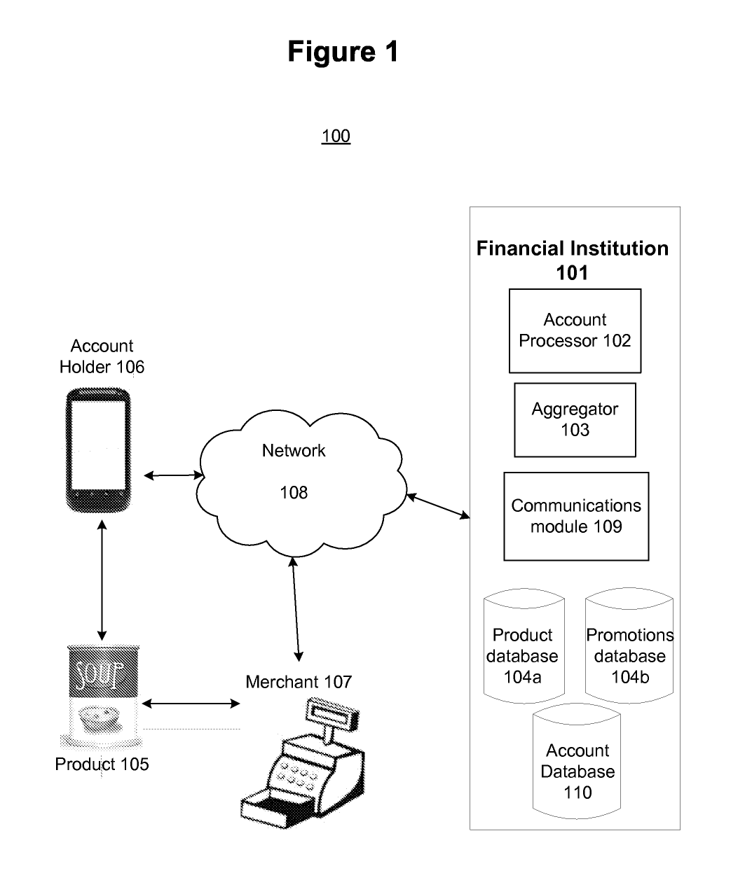

FIG. 1 depicts an example embodiment of a system for providing a mobile budget application to an account holder, according to various embodiments of the disclosure. The system may include various network-enabled computer systems, including, as depicted in FIG. 1 for example, a financial institution 101; comprising an account processor 102, an aggregator 103, communications module 109, a product database 104a, promotions database 104b, and account database 110 which may be included as separate processors or combined into device having a single processor or device having the multiple processors. It is also noted that the system 100 illustrates only a single instance of each component. It will be appreciated that multiple instances of these components may be used. Moreover, the system 100 may include other devices not depicted in FIG. 1.

In various embodiments, aggregator 103, product database 104a, promotions database 104b, and/or the account processor 102 may be separate from financial institution 101. Aggregator 103, product database 104a, promotions database 104b, and/or account processor 102 also may be integrated into, for example, merchant 107.

As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems may also include one or more software applications to enable the creation and provisioning of an account holder's mobile budget application.

The components depicted in FIG. 1 may store information in various electronic storage media, such as, for example, product database 104a and/or promotions database 104b. Electronic information, files, and documents may be stored in various ways, including, for example, a flat file, indexed file, hierarchical database, relational database, such as a product database created and maintained with software from, for example, Oracle® Corporation, Microsoft® Excel file, Microsoft® Access file, or any other storage mechanism.

The components depicted in FIG. 1 may be coupled via one or more networks, such as, for example, network 108. Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the exemplary types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

In various example embodiments, an account holder 106 may be any individual or entity that desires to conduct a financial transaction using one or more accounts held at one or more financial institutions. Also, account holder 106 may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, an account or service that links to an underlying payment account already described, or mobile commerce account.

In various embodiments, account database 110 may maintain information relating to the accounts of consumers. Account database 110 also may include an association of payment data with respective consumers. For example, account database 110 may include an association of a token “123456” with account number “1234 5678 9012 3456,” which belongs to John Q. Cardholder. Account database 110 may also include specifications associated with an account such as account rewards, account terms, including rewards terms, interest rates, late fees, and the like, current account status, and fees associated with the account. Account database 110 also may be associated with a merchant (e.g., merchant 107) and maintain customer information associated with the merchant. For example, a merchant account database may store customer identification information, customer purchase information, including information about past purchases (e.g., shopping lists, items previously purchased, etc.), rewards information and the like.

A financial institution may be, for example, a bank, other type of financial institution, including a credit card provider, for example, or any other entity that offers accounts to customers. An account may or may not have an associated card, such as, for example, a credit card for a credit account or a debit card for a debit account. The account may enable payment using biometric authentication, or contactless based forms of authentication, such as QR codes or near-field communications. The account card may be associated or affiliated with one or more social networking sites, such as a co-branded credit card. The account card also may be associated with, for example, a merchant and/or merchant rewards program (e.g., the Harris Teeter VIC® program or the Giant® Bonus card).

Additionally, or alternatively, an account holder may use one or more mobile budget app accounts that are configured to provide the mobile budget features described herein. A mobile budget app account may be created on a mobile device 106 using a mobile application. In various embodiments, a mobile budget application may be a stand-alone native application executing on, for example, a mobile device or tablet PC. The features of a mobile budget application also may be integrated into, for example, an online banking application associated with a financial institution and/or a mobile application associated with a merchant. An account holder in this disclosure need not have an account with a financial institution. The mobile budget app accounts may be provided by financial institution 101, or merchant 107, or a third party. An account holder may have one or more shoppers accounts with merchants. The mobile budget application described herein may be available to any user or individual with a mobile device, regardless of whether this individual has a financial account.

As used herein, the term mobile device may be, for example, a handheld PC, a phone, a smartphone, a PDA, a tablet computer, or other device. The mobile device may include Near Field Communication (NFC) capabilities, which may allow for communication with other devices by touching them together or bringing them into close proximity. Exemplary NFC standards include ISO/IEC 18092:2004, which defines communication modes for Near Field Communication Interface and Protocol (NFCIP-1). For example, a mobile device may be configured using the Isis Mobile Wallet™ system, which is incorporated herein by reference. Other example NFC standards include those created by the NFC Forum. The mobile device also may include standard wireless capabilities including, for example, Bluetooth® technology

As described in reference to FIG. 1, financial institution 101 may provide an account holder 106 with one or more financial accounts. The financial account may be associated with the account holder's one or more mobile devices. The mobile device may be configured to act as a method of payment at a POS location (merchant 107) using, for example, NFC or any other mobile payment technology. When account holder 106 uses his mobile device at a POS location to perform a financial transaction, the financial transaction may be charged to the mobile payment account. For example, the account holder 106 may use the device in lieu of a credit card to make a purchase merchant 107. The purchase would then be charged to the mobile payment account associated with the account holder device 106. The mobile payment account may be stored in a mobile payment account database at financial institution 101. The account may be a traditional credit card account where the account holder uses a credit card, rewards card, debit card, or similar method of payment to purchase goods and services from one or more merchants 107.

As described in reference to FIG. 1, account processor 102 may be configured to receive location data from the account holder's mobile device via network 108. The location data may be GPS coordinates acquired by the account holder's mobile device. The location data may be an address entered by the account holder into the mobile device. The address may be a street, city, zip code, state, country, etc. The location data also may be the physical address of one or more merchants 107. Account processor 102 may save certain merchant locations based on account holder input received via the mobile device. The account holder may designate one or more merchants as favorites, and the account processor 102 may save in, for example, a database, the location information associated with the one or more merchants, to be accessed at a later time.

Account processor 102 may determine regional tax information based on the location data. Tax information may vary depending on the location. For example, different states may have different sales tax rates. Different cities and counties also may have different and/or additional tax rates. For example, if the location data indicates that the account holder is in San Francisco, Calif., account processor 102 may determine which taxes are associated with that location (e.g., state sales tax, excise tax, city or county sales tax, sin taxes, etc.). Tax information may have been previously stored in one or more databases at or associated with a financial institution 101. Tax information also may be retrieved from one or more third parties (not shown).

Account processor 102 may be configured to create and/or facilitate the creation of a virtual “shopping basket” for the account holder. The virtual shopping basket may be represented as a graphical user interface (GUI) or application programming interface (API) on the account holder's mobile device as part of the mobile budget application. Account processor 102 may create the shopping basket based on commands received from the mobile device. For example, the account holder may input commands via the mobile device to cause account processor 102 to create a shopping basket for a certain shopping trip. The account holder may be planning to go to a local grocery store, and may input commands to create a shopping basket for that trip. For example, the account holder may manually input a shopping basket for a shopping trip by typing it in. Account holder may also import or retrieve a previous shopping basket or list. Account holder may also retrieve a “favorites” list for inclusion in a shopping basket. Also, account processor 102 may automatically create a shopping basket and present it to the account holder on his mobile budget application based on the location data. For example, if the location data shows the account holder to be within a certain distance of a merchant 107 that the account holder had previously designated as a favorite, account processor 102 may automatically create a shopping basket for the account holder to shop at that “favorite” merchant. Account processor 102 may send a message (e.g., a text message, push notification, and/or the like) to the account holder's mobile device 106 to request the account holder's confirmation of the shopping trip with the pre-saved merchant.

Account processor 102 may be configured to receive product identification data from the account holder's mobile device 106, via network 108. Product identification data may be associated with one or more products 105 being sold by merchant 107. In an example embodiment, merchant 107 may be a grocery store, and may sell one or more food products 105. These food products may be perishable and/or imperishable goods and/or other items sold by a grocery store, for example. Merchant 107 may be any other type of store that sells goods or services (such as a hardware store, clothing goods store, furniture store, home appliances store, electronics store, games, music, multimedia, etc.).

Product identification data may include stock-keeping-unit (SKU) data. Product identification data may include Universal Product Code (UPC) barcode data. Product identification data may include data that can be read using Radio Frequency Identification (RFID) technology. The account holder's mobile device 106 may be equipped with one or more barcode scanners, cameras, RFID readers and the like. Account holder 106 may collect product identification data on his or her mobile device by “scanning” the product's bar code using a barcode reader or technology incorporated into a camera that acts as a barcode scanner. The mobile device also may be equipped with one or more cameras that can take a picture of a product's bar code. The account processor 102 may receive this scanned information from the account holder's mobile device via network 108 and lookup corresponding product information in, for example, a product database (e.g., product database 104a).

Account processor 102 may be configured to access product database 104a to retrieve item information based on the product identification data. Item information may have been previously stored in product database 104a. Item information may have been received from one or more merchants 107, manufacturers, advertisers, etc. For example, financial institution 101 may have a relationship with merchant 107 that enables financial institution to access a product database via, for example, network 108. In various embodiments, financial institution 101 may include an API that allows financial institution 101 to look up product information in a product database associated with merchant 107.

A product 105 may have associated item information stored in product database 104a. The item information for product 105 may be associated with product identification data. The item information may include the price of the product set by merchant 107, information about the manufacturer, information about the brand of the product, information about the product's physical dimensions and unit weight, any coupons, promotions, or discounts associated with the product, and other relevant information about the product. Merchant 107 may have previously provided item information associated with each product 105 sold by merchant 107. Merchant 107 may have provided this information to financial institution 101 or product database 104a or account processor 102. Other entities may have previously provided the item information to financial institution 101 or product database 104a or account processor 102.

In some instances, a product 105 may not be labeled with product identification information. For example, produce at a grocery store often does not have a UPC or SKU label. An account holder may weigh the produce using his or her mobile device 106 as a scale. The account holder may weigh the produce using a scale provided at merchant 107. The account holder may enter this weight into the mobile device 106, and may enter other information about the produce (type of fruit or vegetable). Account holder 106 also may use a client device (e.g., client device 202) that may communicate with a scale provided by a merchant to weigh an item. For example, a client device executing the mobile budgeting app as described herein may establish a wireless communication (e.g., Bluetooth® connection) with a merchant scale to receive weight information that may be used to calculate pricing and other information about the product. Account processor 102 may receive this information and retrieve the associated item information from product database 104a.

The account processor 102 may be configured to add the item information including, for example, pricing information to the account holder's virtual shopping basket. The virtual shopping basket may be represented as a list on account holder's mobile device 106. Account processor 102 may allow the account holder to view the accumulated items in his virtual shopping basket on mobile device 106. Account processor 102 may allow the account holder to remove one or more items from the shopping basket. Account processor 102 may update the shopping basket list each time the account holder adds (or removes) a product to the shopping basket.

Account processor 102 may be configured to receive budget data from the account holder's mobile device via, for example, network 108. Budget data may include a maximum monetary amount that the account holder is willing to spend during a shopping trip at one or more merchants 107. The account holder may enter the amount using his or her mobile device 106. The account holder may input the budget data using the mobile device while he or she is on the premises of the one or more merchants 107. The account holder may pre-set the budget data in advance.

Account processor 102 may associate the budget data with the account holder's virtual shopping basket. Account processor 102 may keep track of previous budget data the account holder has entered for past shopping trips and may recommend a budget amount based on previous budget data. The budget data may be broken up into spending categories. For example, the budget data may include a maximum monetary amount for groceries, electronics, clothing, shoes, appliances, furniture, etc. The categories may include monetary amounts for sub-categories. For example, the category for “groceries” may include subcategories for dairy products, fruits & vegetables, meats, snacks, desserts, alcohol, and other subcategories. The account holder may input a monetary amount for each category and/or subcategory into his or her mobile device, and this information may be received by account processor 102 as budget data. The account processor also may keep track of which budgeted items have been inputted into the virtual shopping basket, and notify the account holder about which items remain to be purchased.

Aggregator 103 may be configured to aggregate the item information in the shopping basket with the budget data. For example, as the account processor 102 receives product data for a given product 105, aggregator 103 may add the price information associated with the product 105 (stored as item information in product database 104) to price information in the virtual shopping basket that account holder 106 has already accumulated for that shopping trip. Aggregator 103 may maintain a total cost for all products 105 that the account holder has added to the shopping basket for that shopping trip. Aggregator 103 may determine a total price by aggregating the total cost with tax data associated with the location data. So, for example, assume account holder 106 is shopping at a grocery store, and has created a virtual shopping basket that contains product data for 7 different items, and the total cost of the items is $100. If the grocery store is located in State Y, which has a sales tax of 5%, aggregator 103 would determine the total price for the virtual shopping basket to be $105.

Aggregator 103 may be configured to compare the total price for the virtual shopping basket with the budget data that account holder 106 has provided for that shopping trip. Aggregator 103 may be configured to transmit the current difference between the budget data and the total price for display on the account holder's mobile device 106. So, in the previous example, if the account holder had created a budget of $150 for the shopping trip, aggregator 103 would determine that account holder has $45 remaining to spend ($150-$105). As previously stated, budget data may be broken into categories, and aggregator 103 may be configured to compare category budget data with the total price for each category of products purchased.

Aggregator 103 may retrieve promotion data from promotions database 104b. Promotion data may include coupons, discounts, promotions, and other incentives for account holder. Promotion data have been previously supplied to promotions database 104b by financial institution 101, or merchant 107, or one or more advertisers, or other third parties that may offer purchasers creative ways to save money on purchases of goods and services. Promotions database 104b may include promotion data associated with various merchants and/or products, such as merchant 107 and/or products 105. Promotions data may be specific to account holder 106, such as available rewards that account holder 106 previously accumulated. Promotions data may also be supplied by account holder 106, using his or her mobile device, or other means. Account holder 106 may have a shopper's card from merchant 107, and may scan in the shoppers card using mobile device 106. Account holder 106 may have one or more coupons associated with merchant 107 and/or with various products being added to the virtual shopping cart. Account holder may scan in the coupons in the same way that product data is scanned in and sent to account processor 102.

Aggregator 103 may recalculate the total price based on the promotions data. Aggregator 103 may compare the promotions data to the item information in the account holder's virtual shopping basket to determine if there are discounts or promotions associated with the products account holder is attempting to purchase. Aggregator 103 may apply the promotions data to the total price to reduce the total price accordingly.

Alternatively or additionally, aggregator 103 may recommend other products to account holder based on the promotions data and/or based on the item information in the virtual shopping basket. For example, if the account holder has scanned in product data for three cans of Ragu spaghetti sauce, aggregator 103 may determine that merchant 107 offers Prego spaghetti sauce at a less expensive price, and may recommend the Prego spaghetti sauce to the account holder via his or her mobile device 106. Aggregator 103 may determine (e.g., based on promotions data), that merchant 107 is offering a buy-one-get-one-free deal on Prego spaghetti sauce, and may inform the account holder of this. Aggregator 103 may calculate an alternative total price to show the account holder what the total price would be if he or she used the discounts.

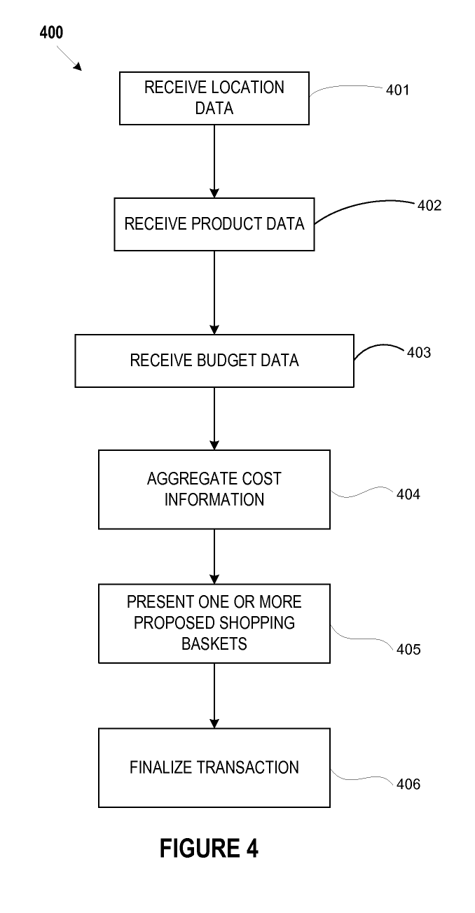

Aggregator 103 may allow the account holder to rank products in the virtual shopping basket by order of importance. Aggregator 103 may determine alternative shopping baskets based on the rankings. Thus, if an account holder designates one product as more important than another product in the virtual shopping cart, aggregator 103 may determine alternative shopping baskets that keep the higher ranked product, while finding other products that are similar to the lower ranked product. Aggregator 103 may compare the total price of the one or more alternative shopping baskets with the budget data, to find the closest or best match. Aggregator 103 may recommend one or more alternative shopping baskets to the account holder based on these and other comparisons. Aggregator 103 may recommend one or more alternative shopping baskets to the account holder based on available promotions and the similarities between the product information in the current shopping basket and other products offered by the merchant (as will be explained further in conjunction with FIG. 4). Aggregator 103 also may cooperate with account processor 12 to notify account holder which, if any, items have not yet been inputted into the virtual basket.

Aggregator 103, account processor 102, or other processors may be configured to allow the account holder to “check-out” the shopping basket and pay for the items listed in the shopping basket. The account holder may present mobile device 106 to merchant 107. Merchant 107 may read the virtual shopping basket. Account holder's account may be charged for the total price of the items in the shopping basket after the aggregator 103 has applied any available promotions, coupons, and/or discounts available. Account holder's one or more accounts may be credited with various rewards and incentives based on the mobile purchases.

Communication module 109 may include various hardware and software components, such as, for example, a repeater, a microwave antenna, a cellular tower, or another network access device capable of providing connectivity between two different network mediums. Communication module 109 may be capable of sending or receiving signals via network. Moreover, communication module 109 may provide connectivity to one or more wired networks and may be capable of receiving signals on one medium such as a wired network and transmitting the received signals on a second medium such as a wireless network.

Communication module 109 also may be operable to receive incoming communications from one or more sources and transmit outgoing communications to one or more sources. For example, communication module may be operable to receive and/or transmit communication to and from a mobile device, or the communication module may be operable to receive communications from and/or transmit communications to a distributed system associated with, for example, a merchant (e.g., merchant 107). For example, a mobile device may communicate with communication module 109 via a network. Additional devices may also be in communication with the communication module 109, either in parallel or in serial connection with the communication module, and additional devices with other communication protocols may be employed to communicate with the communication module.

The mobile budget application described above may be provided to the account holder via one or more websites operated by the financial institution, advertiser, merchant, or a third party host. The mobile budget application may be delivered to the account holder's mobile device as part of a mobile application on his or her mobile device.

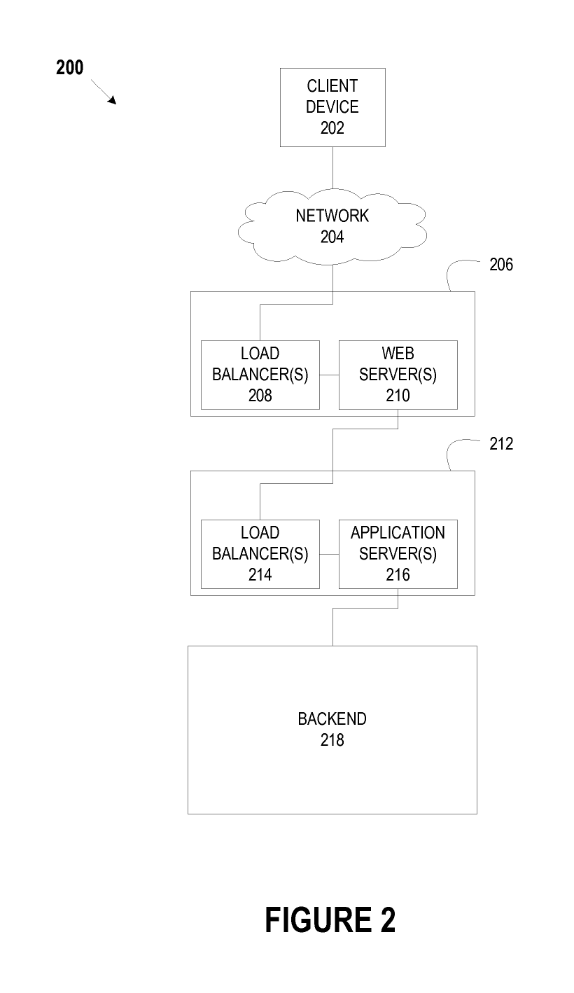

FIG. 2 depicts an example system 200 that may enable a financial institution, for example, to provide network services to its customers. Example system 200 also illustrates examples of merchant systems (e.g., merchant 107). Merchant systems similar to system 200 may enable a financial institution and merchant, for example, to grocery budgeting application to users of client devices (e.g., client device 202). Client device 202 may be similar to the user device used by account holder 106 as described above. Also, network 204 may be similar to network 108 of FIG. 1.

As shown in FIG. 2, system 200 may include a client device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Client device 202 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Client device 202 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 204 may be one or more of a wireless network, a wired network, or any combination of a wireless network and a wired network. For example, network 110 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 110 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 110 may further include one network, or any number of example types of networks mentioned above, operating as a stand-alone network or in cooperation with each other. Network 110 may utilize one or more protocols of one or more network elements to which they are communicatively couples. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 210 may distribute workloads across, for example, web server(S) 216 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 may include software that monitoring the port where external clients, such as, for example, client device 202, connect to access various services of a financial institution, for example. Load balancer(s) 208 may forward requests to one of the application servers 216 and/or backend 218 servers, which may then reply to load balancer 208. This may allow load balancer(s) 208 to reply to client device 202 without client device 202 ever knowing about the internal separation of functions. It also may prevent client devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., client device A 02) through a network (e.g., network 204), such as the Internet. In various examples, web servers, may deliver web pages, relating to, for example, online banking applications and the like, to clients (e.g., client device 202). Web server(s) 210 may use, for example, a hypertext transfer protocol (HTTP or sHTTP) to communicate with client device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 210 may respond with the content of that resource or an error message if unable to do so. The resource may be, for example a file on stored on backend 218. Web server(s) 210 also may enable or facilitate receiving content from client device 202 so client device AO2 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 216 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributed system similar to system 200. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200.

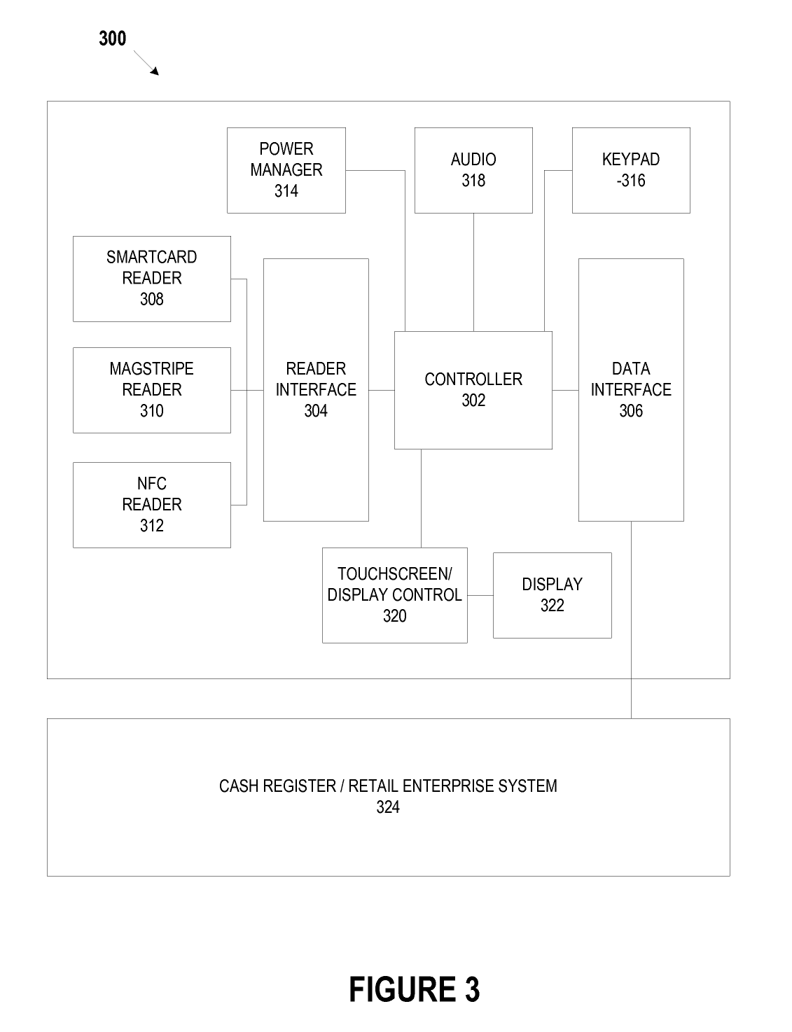

In various examples, backend 218 may include similar components as financial institution 101. In these examples, backend 218 may enable a financial institution, along with the various databases, communication modules and processors associated therewith to provide smart statements. Backend 218 also may include various backend components that may be associated with a merchant. For example, backend 218 may include systems similar to the retail enterprise system 324 as shown and described below in FIG. 3.

FIG. 3 depicts an example Point of Sale (PoS) device 300. PoS device 300 may provide the interface at what a customer or end user makes a payment to the merchant in exchange for goods or services. In various embodiments, numerous features described with respect to PoS device 300 may be implemented into a mobile grocery budgeting application executing on a mobile device (e.g., client device 202). For example, the mobile grocery budgeting application may enable users to “check out” using the mobile grocery budgeting application in a manner similar to as described for a user making a payment using PoS device 300.

PoS device 300 may include and/or cooperate with weighing scales, scanners, electronic and manual cash registers, electronic funds transfer at point of sale (EFTPOS) terminals, touch screens and any other wide variety of hardware and software available for use with PoS device 300. PoS device 300 may be a retail point of sale system and may include a cash register and/or cash register-like computer components to enable purchase transactions. PoS device 300 also may be a hospitality point of sale system and include computerized systems incorporating registers, computers and peripheral equipment, usually on a computer network to be used in restaurant, hair salons, hotels or the like. PoS device 300 may be a wireless point of sale device similar to a PoS device described herein or, for example a tablet computer that is configured to operate as a PoS device, including for example, software to cause the tablet computer to execute point of sale functionality and a card reader such as for example the Capital One® SparkPay card reader, the Square® reader, Intuit's® GoPayment reader, or the like. PoS device 300 also may be a cloud-based point of sale system that can be deployed as software as a service, which can be accessed directly from the Internet using, for example, an Internet browser.

Referring to FIG. 3, an example PoS device 300 is shown. PoS device 300 may include a controller 302, a reader interface 304, a data interface 306, a smartcard reader 308, a magnetic stripe reader 310, a near-field communications (NFC) reader 312, a power manager 314, a keypad 316, an audio interface 318, a touchscreen/display controller 320, and a display 322. Also, PoS device 300 may be coupled with, integrated into or otherwise connected with a cash register/retail enterprise system 324.

In various embodiments, Controller 302 may be any controller or processor capable of controlling the operations of PoS device 300. For example, controller 302 may be a Intel® 2nd Generation Core™ i3 or i5 or Pentium™ G850 processor or the like. Controller 302 also may be a controller included in a personal computer, smartphone device, tablet PC or the like.

Reader interface 304 may provide an interface between the various reader devices associated with PoS device 300 and PoS device 300. For example, reader interface 304 may provide an interface between smartcard reader 308, magnetic stripe reader 310, NFC reader 312 and controller 302. In various embodiments, reader interface 304 may be a wired interface such as a USB, RS232 or RS485 interface and the like. Reader interface 304 also may be a wireless interface and implement technologies such as Bluetooth, the 802.11(x) wireless specifications and the like. Reader interface 304 may enable communication of information read by the various reader devices from the various reader devices to PoS device 300 to enable transactions. For example, reader interface 304 may enable communication of a credit or debit card number read by a reader device from that device to PoS device 300. In various embodiments, reader interface 304 may interface between PoS device 300 and other devices that do not necessarily “read” information but instead receive information from other devices.

Data interface 306 may allow PoS device 300 to pass communicate data throughout PoS device and with other devices including, for example, cash register/retail enterprise system 324. Data interface 306 may enable PoS device 300 to integrate with various customer resource management (CRM) and/or enterprise resource management (ERP) systems. Data interface 306 may include hardware, firmware and software that make aspects of data interface 306 a wired interface. Data interface 306 also may include hardware, firmware and software that make aspects of data interface 306 a wireless interface. In various embodiments, data interface 306 also enables communication between PoS device other devices.

Smartcard reader 308 may be any electronic data input device that reads data from a smart card. Smartcard reader 308 may be capable of supplying an integrated circuit on the smart card with electricity and communicating with the smart card via protocols, thereby enabling read and write functions. In various embodiments, smartcard reader 308 may enable reading from contact or contactless smart cards. Smartcard reader 308 also may communicate using standard protocols including ISO/IEC 7816, ISO/IEC 14443 and/or the like or proprietary protocols.

Magnetic stripe reader 310 may be any electronic data input device that reads data from a magnetic stripe on a credit or debit card, for example. In various embodiments, magnetic stripe reader 310 may include a magnetic reading head capable of reading information from a magnetic stripe. Magnetic stripe reader 310 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., format A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe. In various embodiments, track 3 transmission channels may be used for transmitting dynamic data packet information to further enable enhanced token-based payments. Track 3 transmission channels also may be used to transmit, for example, geolocation data associated with a user, product data relating to the purchase (e.g., product information, stock keeping unit (SKU) level data, and/or any other information that may be used to provide purchase-driven smart statements. PoS device 300 may communicate and or cooperate with the user device to provide the information into track 3 transmission channels. Other methods for providing product level data to a financial institution. For example, a merchant can transmit the product data for each transaction to a financial institution along with information that identifies the transaction.

NFC reader 312 may be any electronic data input device that reads data from a NFC device. In an exemplary embodiment, NFC reader 312 may enable Industry Standard NFC Payment Transmission. For example, the NFC reader 312 may communicate with a NFC enabled device to enable two loop antennas to form an air-core transformer when placed near one another by using magnetic induction. NFC reader 312 may operate at 13.56 MHz or any other acceptable frequency. Also, NFC reader 312 may enable a passive communication mode, where an initiator device provides a carrier field, permitting answers by the target device via modulation of existing fields. Additionally, NFC reader 312 also may enable an active communication mode by allowing alternate field generation by the initiator and target devices.

In various embodiments, NFC reader 312 may deactivate an RF field while awaiting data. NFC reader 312 may receive communications containing Miller-type coding with varying modulations, including 100% modulation. NFC reader 312 also may receive communications containing Manchester coding with varying modulations, including a modulation ratio of approximately 10%, for example. Additionally, NFC reader 312 may be capable of receiving and transmitting data at the same time, as well as checking for potential collisions when the transmitted signal and received signal frequencies differ.

NFC reader 312 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 312 may be able to utilize transmission protocols and methods that are developed in the future using other frequencies or modes of transmission. NFC reader 312 also may be backwards-compatible with existing payment techniques, such as, for example RFID. Also, NFC reader 312 may support transmission requirements to meet new and evolving payment standards including internet based transmission triggered by NFC. In various embodiments, NFC reader 312 may utilize MasterCard's® PayPass and/or Visa's® PayWave and/or American Express'® ExpressPay systems to enable transactions.

Although not shown and described, other input devices and/or readers, such as for example, barcode readers and the like are contemplated.

Power manager 314 may be any microcontroller or integrated circuit that governs power functions of PoS device 300. Power manager 314 may include, for example, firmware, software, memory, a CPU, a CPU, input/output functions, timers to measure intervals of time, as well as analog to digital converters to measure the voltages of the main battery or power source of PoS device 300. In various embodiments, Power manager 314 remain active even when PoS device 300 is completely shut down, unused, and/or powered by the backup battery. Power manager 314 may be responsible for coordinating many functions, including, for example, monitoring power connections and battery charges, charging batteries when necessary, controlling power to other integrated circuits within PoS device 300 and/or other peripherals and/or readers, shutting down unnecessary system components when they are left idle, controlling sleep and power functions (on and off), managing the interface for built-in keypad and trackpads, and/or regulating a real-time clock (RTC).

Keypad 316 may any input device that includes a set of buttons arranged, for example, in a block or pad and may bear digits, symbols and/or alphabetical letters. Keypad 316 may be a hardware-based or mechanical-type keypad and/or implemented in software and displayed on, for example, a screen or touch screen to form a keypad. Keypad 316 may receive input from a user that pushed or otherwise activates one or more buttons on keypad 316 to provide input.

Audio interface 318 may be any device capable of providing audio signals from PoS device 300. For example, audio interface may be a speaker or speakers that may produce audio signals. In various embodiments, audio interface 318 may be integrated within PoS device 300. Audio interface 318 also may include components that are external to PoS device 300.

Touchscreen/display control 320 may be any device or controller that controls an electronic visual display. Touchscreen/display control 320 may allow a user to interact with PoS device 300 through simple or multi-touch gestures by touching a screen or display (e.g., display 322). Touchscreen/display control 320 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 320 may receive inputs from the touchscreen and process the received inputs. Touchscreen/display control 320 also may control the display on PoS device 300, thereby providing the graphical user interface on a display to a user of PoS device 300.

Display 322 may be any display suitable for a PoS device. For example, display 322 may be a TFT, LCD, LED or other display. Display 322 also may be a touchscreen display that for example allows a user to interact with PoS device 300 through simple or multi-touch gestures by touching a screen or display (e.g., display 322). Display 322 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 322 may receive inputs from control gestures provided by a user. Display 322 also may display images, thereby providing the graphical user interface to a user of PoS device 300.

Cash register/retail enterprise system 324 may me any device or devices that cooperate with PoS device 300 to process transactions. Cash register/retail enterprise system 324 may be coupled with other components of PoS device 300 via, for example, a data interface (e.g., data interface 306) as illustrated in FIG. 3. Cash register/retail enterprise system 324 also may be integrated into PoS device 300.

In various embodiments, cash register/retail enterprise system 324 may be a cash register. Example cash registers may include, for example, mechanical or electronic devices that calculate and record sales transactions. Cash registers also may include a cash drawer for storing cash and may be capable of printing receipts. Cash registers also may be connected to a network to enable payment transactions. Cash registers may include a numerical pad, QWERTY or custom keyboard, touch screen interface, or a combination of these input methods for a cashier to enter products and fees by hand and access information necessary to complete the sale.

In various embodiments, cash register/retail enterprise system 324 may comprise an retail enterprise system and/or a customer relationship management system. Retail enterprise system 324 may enable retain enterprises to manage operations and performance across a retail operation. Retail enterprise system 324 may be a stand-alone application in, for example, individual stores, or may be interconnected via a network. Retail enterprise system 324 may include various point of sale capabilities, including the ability to, for example, customize and resize transaction screens, work with a “touch screen” graphical user interface, enter line items, automatically look up price (sales, quantity discount, promotional, price levels), automatically compute tax, VAT, look up quantity and item attribute, display item picture, extended description, and sub-descriptions, establish default shipping services, select shipping carrier and calculate shipping charges by weight/value, support multi-tender transactions, including cash, check, credit card, and debit card, accept food stamps, place transactions on hold and recall, perform voids and returns at POS, access online credit card authorizations and capture electronic signatures, integrate debit and credit card processing, ensure optional credit card discounts with address verification, support mix-and-match pricing structure, discount entire sale or selected items at time of sale, add customer account, track customer information, including total sales, number of visits, and last visit date. issue store credit, receive payment(s) for individual invoices, process deposits on orders, search by customer's ship-to address, create and process layaway, back orders, work orders, and sales quotes, credit items sold to selected sales reps, view daily sales graph at the PoS, view and print journals from any register, preview, search, and print journals by register, batch, and/or receipt number, print X, Z, and ZZ reports, print receipts, invoices, and pick tickets with logos/graphics, print kit components on receipt, reprint receipts, enter employee hours with an integrated time clock function, and/or sell when the network/server is down with an offline PoS mode. Retail enterprise system 324 also may include inventory control and tracking capabilities, reporting tools, customer management capabilities, employee management tools, and may integrate with other accounting software.

FIG. 4 is a flow chart illustrating a method for providing a mobile budget application to an account holder. This example method is provided by way of example. The method 400 shown in FIG. 4 can be executed or otherwise performed by one or more combinations of various systems. The method 400 as described below may be carried out by the system for providing a mobile budget application to an account holder as shown in FIGS. 1-3, by way of example, and various elements of that system are referenced in explaining the method of FIG. 4. Each block shown in FIG. 4 represents one or more processes, methods, or subroutines in the example method 400. Referring to FIG. 4, the example method 400 may begin at block 401.

In block 401, method 400 may include receiving location data. In one example, user A may have a mobile budget application on his mobile device, e.g. an iPhone or like device. User A may decide to shop for groceries at a grocery store (e.g., Whole Foods®) and may create a virtual shopping basket on his iPhone using a mobile budget application. User A may enter the address of the Whole Foods®. Additionally, or alternatively, the mobile budget application also may retrieve user A's current location using GPS-enabled software and/or hardware on user A's iPhone. An account processor (e.g., account processor 102) may receive the location data. The location data may be a street address for the Whole Foods®. The location data also may be GPS coordinates associated with a merchant location (e.g., Whole Foods®).

User A may create a virtual shopping basket for the current shopping trip to Whole Foods®. User A may use the mobile budget application to give the shopping basket a name (e.g., “Feb. 2, 2013 shopping trip to Whole Foods”). The mobile budget application may save the shopping basket for that particular trip and associate the current date and time with the shopping basket. User A may have one or more mobile payment accounts with financial institution 101. At least one of these payment accounts may be associated with user A's mobile device (e.g., iPhone). The mobile budget application may associate one or more mobile payment accounts with the shopping basket for that trip to Whole Foods®. Such an association may enable user A to “check out” using the mobile device and mobile budget application when user is finished shopping.

An account processor (e.g., account processor 102) may determine tax information based on the location data. For example, if the Whole Foods® is located in Richmond, Va., the account processor may determine that Virginia has a state sales tax rate of 4%, for example. An account processor (e.g., account processor 102) may determine other local and state taxes based on the location data. Method 400 may proceed to block 402.

At block 402, method 400 may receive product data. As user A shops at Whole Foods®, user A may add one or more food or other items and other products to the virtual shopping basket by, for example, inputting product data into the mobile budgeting application. Product data may include, for example, stock-keeping-unit (SKU) data. Product data also may include Universal Product Code (UPC) barcode data. Product data may include data that can be read using Radio Frequency Identification (RFID) technology. User A's mobile device (e.g., iPhone) may be equipped with one or more RFID readers. User A also may scan product data on his or her mobile device by scanning the product's bar code. For example, user A may use a camera associated with the mobile device (e.g., iPhone) to take an image of the product bar code. User A's mobile device may then analyze the image, using for example, image analysis tools and/or software associated with user A's mobile device, to derive product data. The product data may be received by account processor 102 via network 108.

An account processor (e.g., account processor 102) may be configured to access a product database (e.g., product database 104a or a like database associated with merchant 107) to retrieve item information based on the product identification data. Item information may have been previously stored in product database 104s. Item information may have been received from one or more merchants 107, manufacturers, advertisers, etc. If user A scans in the product data for a can of soup, the account processor (e.g., account processor 102) may use the product data to retrieve the unit price for the can of soup, the brand, the weight, the can's dimensions, and other information associated with the can of soup (such as images and/or logos). When user A scans in the can of soup, account processor may transmit a message to user A's mobile device (e.g., iPhone) asking if user A wants to add the soup to his shopping basket. An account processor (e.g., account processor 102) may automatically add the can of soup to user A's shopping basket. Once the can of soup is added to the shopping basket, the display on user A's mobile device may be updated to include the item information associated with the can of soup.

User A also may want to add one or more produce or other weighable items to his virtual shopping basket. User A may weigh the items using a scale associated with his iPhone. User A may weigh the items at a scale on the premises at Whole Foods and input the weight information into the mobile device. User A also may use, for example, Bluetooth® technology to establish a connection with a Bluetooth®-enabled scale associated with the merchant to receive weight information from the scale via the Bluetooth® connection. The weight information may be received by a communication module (e.g., communication module 109) and/or an account processor (e.g., account processor 102), and the associated item information may be provided to User A's mobile device. Method 400 may continue at block 403.

In block 403, method 400 may receive budget data. Budget data may be received at an earlier step in the process, such as when User A first creates the shopping basket for the trip to Whole Foods®. Budget information also may be received contemporaneously with user A using the mobile budget application while shopping. An account processor (e.g., account processor 102) may be configured to receive, via, for example communication module 109, budget data from User A's mobile device. Budget data may include a maximum monetary amount that the account holder is willing to spend during the shopping trip. In this example, User A may want to spend $150 for this shopping trip to Whole Foods®. User A may enter the amount using the mobile budget application on user A's mobile device (e.g., iPhone). User A may have pre-set the budget data to be the same every month, or the dependent on the merchant, or different depending on the month. Method 400 may proceed to block 404.

At block 404, method 400 may aggregate cost information. As User A adds food products to his shopping basket, as described above, an aggregator (e.g., aggregator 103) may continuously update the total price for the shopping basket. Total price may be determined by adding the cost of each food item in the shopping basket, calculating any taxes, and determining whether any discounts or coupons may be applied. User A may have a shopper's card at Whole Foods® and may scan or enter in (using user A mobile device) identifying information associated with his shopper's card. An aggregator (e.g., aggregator 103) may apply any available discounts to the shopping basket based on this information. User A may scan or enter in information (using, for example, user A mobile device) relating to any coupons he may have. An aggregator (e.g., aggregator 103) may apply any discounts to the shopping basket based on this coupon information.

An aggregator (e.g., aggregator 103) may compare the total price to the budget data. The aggregator may continuously compare this information each time the shopping basket is updated whenever an item is added or removed. The aggregator may inform User A how much user A has remaining for his shopping trip by subtracting the total price from the budget data. The aggregator (e.g., aggregator 103) may present this information on User A's mobile device using the mobile budget application. The mobile budget application may display User A's budget for the shopping trip, the total price of all the items in his shopping basket, and the current amount over or under budget.

For example, if at a given point in the shopping trip, User A has $100 of items in his shopping basket, the total price on User A's mobile budget application would be displayed as $104 ($100+4% sales tax). The amount under budget would be displayed as $46 ($150 total budget−$104 total price). This display may be continuously updated each time User A adds (or removes) an item to or from the shopping basket. Method 400 may proceed to block 405.

In block 405, method 400 may present one or more proposed shopping baskets. An aggregator (e.g., aggregator 103) may create one or more proposed (or alternative) shopping baskets based on item information, product data, promotions data (such as coupons, discounts, available rewards, etc.) and other information. Promotions data may have been previously supplied by the merchant (e.g., Whole Foods®), suppliers, producers, advertisers, or other merchants. User A may be able to scan in promotions data by scanning coupons or one or more shopper cards. For example, User A may have added two boxes of Kellogg's Corn Flakes cereal to his shopping cart, at a cost of $3.50 a box. An aggregator (e.g., aggregator 103) may retrieve promotional data associated with this product from a promotions database (e.g., promotions database 104b or a like promotions database associated with a merchant). The aggregator may retrieve item information for one or more products that are similar to the Corn Flakes from a product database (e.g., products database 104a or a like products database associated with a merchant). For example, the merchant (e.g., Whole Foods®) may be offering a buy-one-get-one-free deal on Cheerios. This promotion information may be stored in the promotions database. One box of Cheerios may be selling for $4 at Whole Foods. An aggregator (e.g., aggregator 103) may recommend to User A, via a message transmitted through the mobile budget application) that he purchase two boxes of Cheerios instead of the two boxes of Corn Flakes. The Aggregator may present the savings in terms of the cost/weight unit for each item. The aggregator also may present a proposed shopping basket that includes the two boxes of Cheerios instead of the two boxes of Corn Flakes. This would result in a savings of $3. The aggregator may be configured to display these savings to User A on his mobile budget application.

An aggregator (e.g., aggregator 103) may present proposed shopping baskets only if the total price of the current shopping basket exceeds the budget data for that trip. An aggregator (e.g., aggregator 103) may present proposed shopping baskets regardless of whether the account holder is under or over budget. User A may choose a proposed shopping basket to replace the current shopping basket in user A's mobile budget application. An aggregator (e.g., aggregator 103) may update the total price information accordingly. Method 400 may continue to block 406.

In block 406, method 400 may include finalizing the transaction. User A may present his shopping basket for checkout at the merchant. The merchant (e.g., Whole Foods®) may charge the items in the shopping basket to one or more of User A's payment accounts. User A may link the shopping basket to one or more financial accounts. For example, user A may have a mobile payment account with a financial institution. The mobile budget application may be configured to allow the user to link the shopping basket with the mobile payment account. The user could input one or more commands to “check out” the shopping basket, and the mobile payment account would be automatically charged for the value of the items in the shopping basket. In this way, user A would not have to proceed through a checkout lane at the store. Also, the transaction may be completed in conjunction with a register or other device equipped with NFC capabilities at the merchant. The transaction may be accomplished online.

It is further noted that the software described herein maybe tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system for providing a mobile shopping budget application, comprising:
an account processor that receives, via a network, location data associated with the current location of an account holder, product data, and budget data;
a database that stores the received location, product and budget data; and
an aggregator that determines a total price based on at least the location data, product data, and budget data, and provides a virtual shopping basket to the account holder based at least on the product data and budget data.

2. The system according to claim 1, further comprising:
a database that stores tax rate information for a plurality of locations; and
a tax calculator that determines a tax rate associated with the current location of the account holder using the stored tax rate information, wherein
the aggregator further determines the total price based on the determined tax rate and provides the virtual shopping basket based at least on the product data and tax rate.

3. The system according to claim 1, further comprising:
a database that stores promotion information associated with a plurality of promotions, wherein
the aggregator further determines the total price based on the promotion information and provides the virtual shopping basket based at least on the product data and promotion information.

4. The system according to claim 1, wherein the product data is stored in a database associated with a merchant.

5. The system according to claim 3, wherein the promotion information is stored in a database associated with a merchant.

6. A mobile device for providing a mobile shopping budget application, comprising:
a global positioning module that determines the location of the mobile device;
an input/output interface that receives and transmits, via a network, product data and the location of the mobile device;
an interface that receives inputted budget data;
local storage that stores the location of the mobile device, product and budget data; and
a processor that determines a total price based on at least the product data and budget data, and provides a virtual shopping basket to a user of the mobile device based at least on the product data and budget data.

7. The system according to claim 6, wherein the input/output interface further receives tax rate information associated with the location of the mobile device, the local storage stores the tax rate information, and the processor further determines the total price based on the tax rate information and provides the virtual shopping basket based at least on the product data and tax rate information.

8. The system according to claim 6, wherein the input/output interface receives promotion information and the processor further determines the total price based on the promotion information and provides the virtual shopping basket based at least on the product data and promotion information.

9. The system according to claim 6, wherein the product data is stored in a database associated with a merchant.

10. The system according to claim 8, wherein the promotion information is stored in a database associated with a merchant.

11. The system according to claim 6, further comprising;
a scale for weighing a product and determining a product weight, wherein the product weight is stored in the local storage, and wherein the processor further determines the total price based on the product weight.

12. The system according to claim 6, further comprising:
in interface that connects to a scale and receives a product weight, wherein the product weight is stored in the local storage, and wherein the processor further determines the total price based on the product weight.

13. The system according to claim 12, wherein the interface is the input/output interface.

14. A method for providing a mobile shopping budget, comprising:
receiving, via a network, location data from a mobile device associated with a user;
receiving, via a network, identifying data from the mobile device for one or more products, wherein the identifying data for each of the one or more products comprises price data;
receiving, via a network, budget data from the mobile device;
aggregating the price data associated with the one or more products with the location data to determine cost data;
comparing the cost data with the budget data; and
providing the user with the results of the comparison between the cost data and the budget data.

15. The method according to claim 14, further comprising recommending one or more promotions to the user based on the comparison between the cost data and budget data.

16. The method according to claim 14, further comprising:
determining a tax rate associated with the location data of mobile device.

17. The system according to claim 14, wherein the identifying data is received from a [symbol]
